(19) United States
(12) Patent Application Publication
(10) Pub. No.: US 2023/0269308 A1
(43) Pub. Date: Aug. 24, 2023

(54) COMMUNICATION SYSTEM, COMMUNICATION METHOD, RELAY SERVER AND PROGRAM

(71) Applicant: NIPPON TELEGRAPH AND TELEPHONE CORPORATION, Tokyo (JP)

(72) Inventors: Tomohiko IKEDA, Musashino-shi, Tokyo (JP); Satoshi NARIKAWA, Musashino-shi, Tokyo (JP); Takuya ABE, Musashino-shi, Tokyo (JP)

(73) Assignee: NIPPON TELEGRAPH AND TELEPHONE CORPORATION, Tokyo (JP)

(21) Appl. No.: 18/020,207

(22) PCT Filed: Aug. 21, 2020
(86) PCT No.: PCT/JP2020/031636

§ 371 Date: Feb. 7, 2023

(51) Int. Cl. H04L 69/14; H04L 69/16

(52) U.S. Cl. CPC H04L 69/14; H04L 69/16

(57) ABSTRACT

An objective of the present disclosure is to enable a terminal device compatible with an MPTCP to perform communication using the MPTCP even with a service server incompatible with the MPTCP.

In a communication system, a terminal device and a service server incompatible with a multipath transmission control protocol (MPTCP) transmit and receive a packet. The communication system includes a relay server connected between the service server and the terminal device and determines whether the terminal device is compatible with the MPTCP. When the terminal device is compatible with the MPTCP, the relay server establishes an MPTCP main session and sub-session, establishes a transmission control protocol (TCP) session with the service server, transmits and receives a packet to and from the service server using the TCP session, and transmits and receives a packet to and from the terminal device using the MPTCP main session and sub-session.

### TECHNICAL FIELD

The present disclosure relates to a communication system using MPTCP.

### BACKGROUND ART

When both a user terminal and a service server side (termination server) are incompatible with MPTCP in a multipath transmission control protocol (MPTCP) of the related art, the MPTCP cannot be used (for example, see Non Patent Document 1). For a technology annexed to a session establishment by 3-way handshake of TCP, it is essential for the service server side to be compatible with the MPTCP in order to use the MPTCP.

Although currently available user terminals are mostly compatible with the MPTCP (patch distribution of iOS later than iOS7, android, and linux ends), the service server side is incompatible with the MPTCP, which has been a factor preventing the MPTCP from becoming widespread. In the MPTCP, a transmission control protocol (TCP) option area is used to check that both a user terminal and a service server introduce the MPTCP, and then a multipath connection is performed. Accordingly, it is indispensable for the user terminal and the service server side to introduce the MPTCP.

### CITATION LIST

### Non Patent Literature

[NPL 1] RFC8684-TCP Extensions for Multipath Operations with Multiple Addresses

### SUMMARY OF INVENTION

### Technical Problem

An objective of the present disclosure is to enable a user terminal compatible with an MPTCP to perform communication using the MPTCP even with a service server incompatible with the MPTCP.

### Solution to Problem

Accordingly, the present disclosure proposes that mounting of the MPTCP on a service server can be omitted by involving a relay server.

Specifically, a communication system of the present disclosure is a communication system in which a terminal device and a service server incompatible with a multipath transmission control protocol (MPTCP) transmit and receive a packet.

The communication system includes a relay server connected between the service server and the terminal device.

The relay server determines whether the terminal device is compatible with the MPTCP.

When the terminal device is compatible with the MPTCP,
the relay server establishes an MPTCP main session and sub-session with the terminal device,
establishes a transmission control protocol (TCP) session with the service server,
transmits and receives a packet to and from the service server using the TCP session, and
transmits and receives a packet to and from the terminal device using the MPTCP main session and sub-session,

Specifically, the relay server of the present disclosure is a relay server connected between a terminal device and a service server incompatible with a multipath transmission control protocol (MPTCP).

The relay server determines whether the terminal device is compatible with the MPTCP.

When the terminal device is compatible with the MPTCP,
the relay server establishes an MPTCP main session and sub-session with the terminal device,
establishes a transmission control protocol (TCP) session with the service server,
transmits and receives a packet to and from the service server using the TCP session, and
transmits and receives a packet to and from the terminal device using the MPTCP main session and sub-session,

Specifically, a communication method according to the present disclosure is a communication method executed by a relay server connected between a terminal device and a service server incompatible with a multipath transmission control protocol (MPTCP).

It is determined whether the terminal device is compatible with the MPTCP.

When the terminal device is compatible with the MPTCP,
an MPTCP main session and sub-session are established with the terminal device,
a transmission control protocol (TCP) session is established with the service server,
a packet is transmitted to and received from the service server using the TCP session, and
a packet is transmitted to and received from the terminal device using the MPTCP main session and sub-session.

Specifically, a program according to the present disclosure is a program causing a computer to implement each functional unit included in the relay server and is a program causing a computer to perform steps of a communication method performed by a communication device according to the present disclosure.

### Advantageous Effects of Invention

According to the present disclosure, a terminal device compatible with the MPTCP can perform communication using MPTCP even with a service server incompatible with the MPTCP.

### BRIEF DESCRIPTION OF DRAWINGS

FIG. 1 is a diagram illustrating an exemplary configuration of a system according to the present disclosure.

FIG. 2 is a diagram illustrating an exemplary configuration of a relay server.

FIG. 3 is a flowchart illustrating an example of a flow until a service is started between a user terminal and a service server.

FIG. 4 is a flowchart illustrating an example of a flow until the service is started between a user terminal 93 and a service server 92.

FIG. 5 is a diagram illustrating an example of an IP rewriting operation.

FIG. 6 is a diagram illustrating an example of a session establishment process through TCP port number unification.

FIG. 7 is a diagram illustrating an example of a sequence at the time of connection of a user terminal in the related art.

FIG. 8 is a diagram illustrating an example of a sequence at the time of connection of a user terminal in an uplink direction according to the present disclosure.

FIG. 9 is a diagram illustrating an example of a sequence at the time of connection of a user terminal in a downlink direction according to the present disclosure.

FIG. 10 is a diagram illustrating an example of a TCP option format.

FIG. 11 is a diagram illustrating an example of an MPTCP format.

FIG. 12 is a diagram illustrating an example of sequence management and an option storage area.

### DESCRIPTION OF EMBODIMENTS

Hereinafter, an embodiment of the present disclosure will be described in detail with reference to the drawings. The present disclosure is not limited to the embodiment described below. The embodiments are merely exemplary and the present disclosure can be implemented in various modified and improved modes based on the knowledge of those skilled in the art. Constituent elements with the same reference signs in the specifications and the drawings are identical to each other.

### Points of Invention

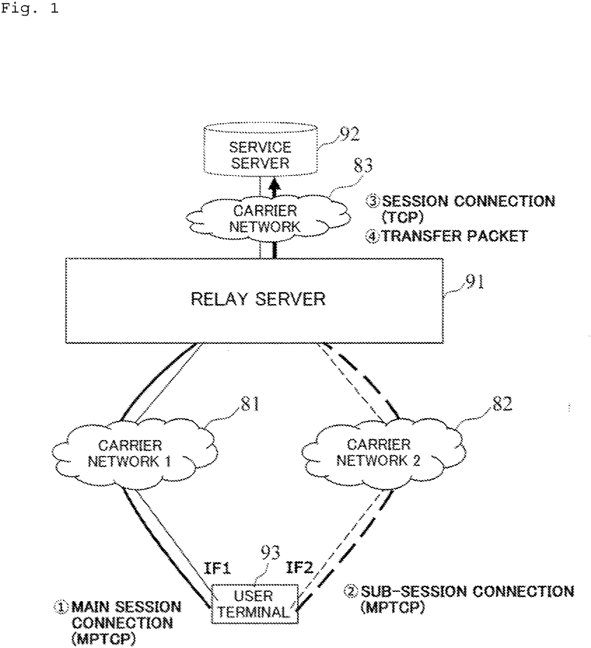

FIG. 1 is a diagram illustrating an exemplary configuration of a system according to the present disclosure. The communication system according to the present disclosure includes a user terminal 93 that functions as a terminal device, carrier networks 81 to 83, an MPTCP-incompatible service server 92 that provides Internet services, and a relay server 91. A device according to the present disclosure can also be realized by a computer and a program, and the program can be recorded in a recording medium or can also be provided via a network.

The user terminal 93 first establishes a main session with the service server 92 via a main flow, and subsequently checks whether the MPTCP is compatible between the user terminal 93 and the service server 92, and establishes a sub-session by a sub-flow.

In the MPTCP of the related art, after a connection is established between the user terminal 93 and the service server 92 by 3-way handshake, a connection of multipaths is started. In the MPTCP technology of the related art, the service server 92 side checks a TCP option area using the TCP option area, checks whether the MPTCP is compatible between the user terminal 93 and the service server 92, and subsequently starts a connection flow in multipaths.

According to an aspect of the present disclosure, the relay server 91 monitors a packet. When target data is checked in the TCP option area, a destination address of the packet is rewritten from the service server 92 to the relay server 91. Thereafter, the user terminal 93 establishes a connection with the relay server 91 by 3-way handshake, and starts the connection of the multipaths. The relay server 91 establishes a connection with the user terminal 93 and subsequently transfers a packet to the service server 92.

In the communication system according to the present disclosure, the service server 92 can realize the MPTCP without mounting the MPTCP. Therefore, the present disclosure can achieve improvement of failure resistance and a throughput by realizing multipaths.

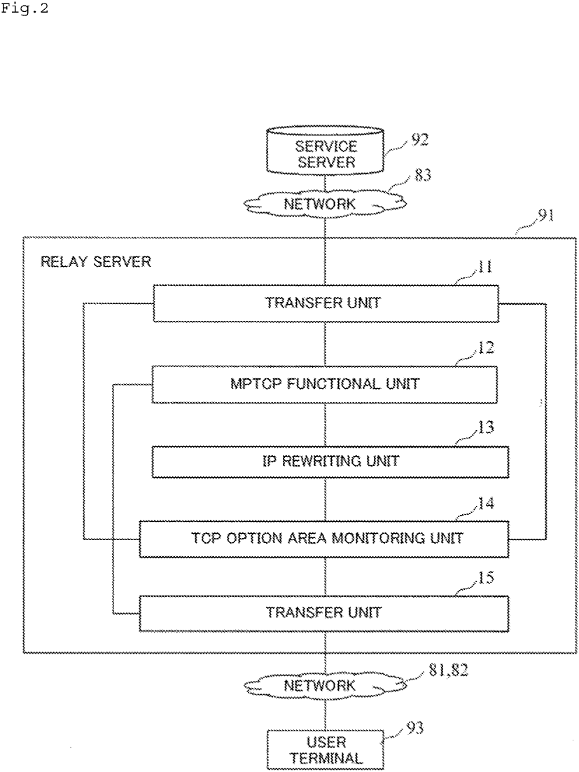

FIG. 2 is a diagram illustrating an exemplary configuration of a relay server. The relay server 91 includes a TCP option area monitoring unit 14, an IP rewriting unit 13, an MPTCP functional unit 12, and transfer units 11 and 15.

The user terminal 93 is connected to the relay server 91 via the carrier networks 81 and 82. The TCP option area monitoring unit 14 is connected to the IP rewriting unit 13, the IP rewriting unit 13 is connected to the MPTCP functional unit 12, and the MPTCP functional unit 12 is connected to the service server 92 via the carrier network 83.

MP_CAPABLE data is used to check that each user terminal 93 is compatible with the MPTCP between the user terminal 93 and the service server 92. This is an option included in the first synchronous packet (SYN). The MPTCP-compatible checking is performed by detecting the data. The TCP option area monitoring unit 14 monitors the MP_CAPABLE included in the synchronous packet. When MP_CAPABLE data is included, the IP rewriting unit 13 rewrites a destination IP address, and the MPTCP functional unit 12 establishes a session between the user terminal 93 and the relay server 92.

### Basic Flow of Uplink

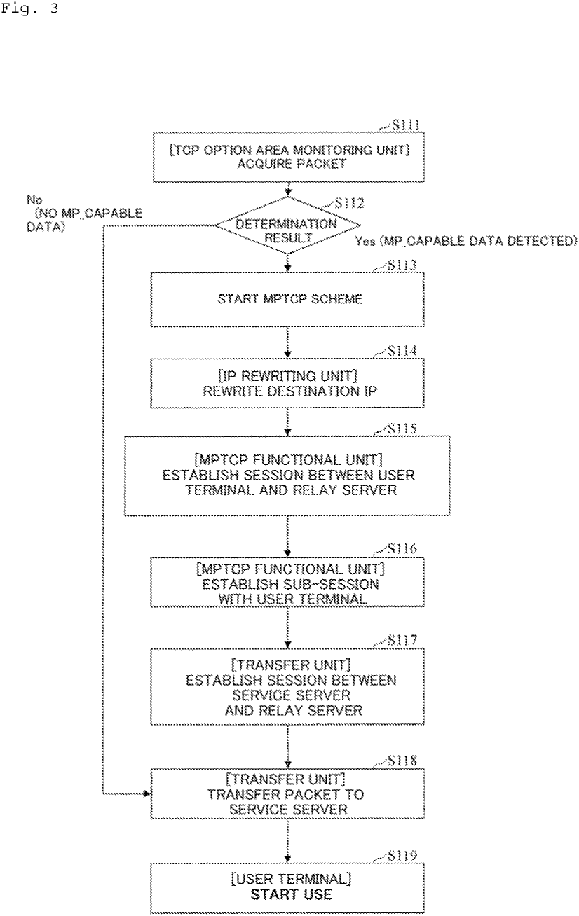

FIG. 3 is a flowchart illustrating an example of a flow until a service is started between a user terminal and a service server. When the TCP option area monitoring unit 14 of the relay server 91 acquires a packet (S111), an MPTCP scheme is started.

When the TCP option area monitoring unit 14 of the relay server 91 detects MP_CAPABLE included in a synchronous packet (SYS) of the MPTCP (Yes in S112), the TCP option area monitoring unit 14 starts the MPTCP scheme (S113).

The IP rewriting unit 13 of the relay server 91 rewrites a destination IP address which is the service server 92 to the relay server 91 (S114). The MPTCP functional unit 12 performs 3-way handshake between the user terminal 93 and the relay server 91 on a packet of which a destination address is the relay server 91 to establish a main session (S115).

After the main session is established, the MPTCP functional unit 12 establishes a sub-session with the user terminal 93 (S116) and completes the multipath connection.

After establishing a session between the user terminal 93 and the relay server 91 (S117), the transfer unit 11 of the relay server 91 transfers all the packets addressed to the service server 92 to the service server 92 (S118).

In step S118 after the session of step S117 is established, the relay server 91 transfers the packet of the service server 92 to the service server 92 without the destination IP changing the IP address. When the service server 92 receives the packet, the relay server 91 rewrites the transmission source IP address to the IP address of the user terminal and then transfers the packet in order to pretend that the service server 92 and the user terminal 93 are directly connected. Then, the processing of the flowchart illustrated in the drawing ends.

### Basic Flow of Downlink

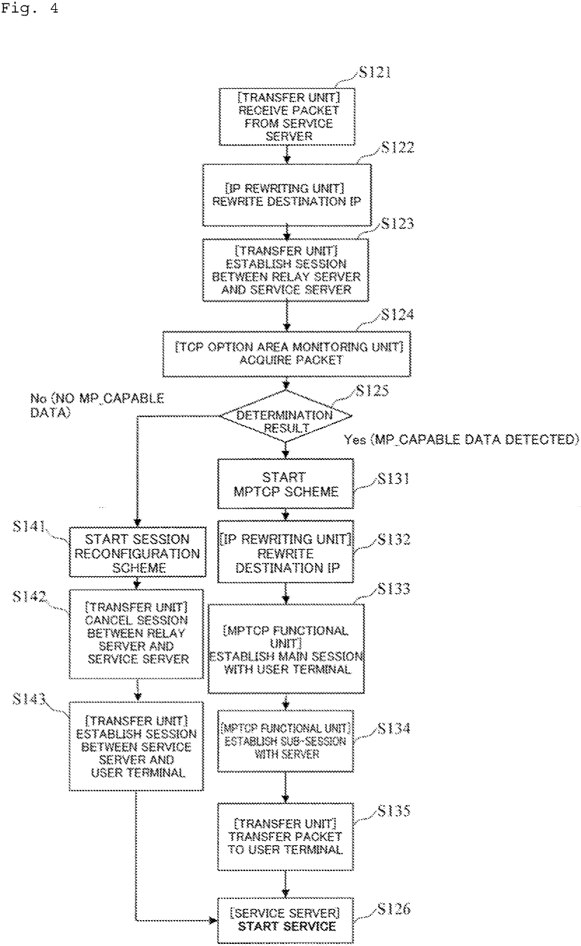

FIG. 4 is a flowchart illustrating an example of a flow until a service is started between the user terminal 93 and the service server 92. When the service server 92 transmits a packet addressed to the user terminal 93 and the relay server 91 receives the packet, a flow starts (S121).

The IP rewriting unit 13 of the relay server 91 changes a destination IP of the received packet from the user terminal 93 to the relay server 91 (S122) and establishes a session between the service server 92 and the relay server 91 (S123).

When the TCP option area monitoring unit 14 of the relay server 91 detects MP_CAPABLE included in a synchronization packet (SYS) of the MPTCP received from the user terminal 93 (Yes in S125), an MPTCP scheme starts (S131).

The IP rewriting unit 13 of the relay server 91 rewrites the destination IP address of the packet received from the user terminal 93 from the service server 92 to the relay server 91 (S132). The MPTCP functional unit 12 rewrites a destination IP address on a packet of which a destination address received from the user terminal 93 is the service server 92 to the relay server 91 (S132) and subsequently performs 3-way handshake between the user terminal 93 and the relay server 92 to establish a session (S133).

Thereafter, the MPTCP functional unit 12 of the relay server 91 establishes a main session with the user terminal 93 (S133) and subsequently establishes a sub-session (S134) to complete a multipath connection.

After the session between the user terminal 93 and the relay server 91 is established, the transfer unit 15 of the relay server 91 transfers all the packets addressed to the user terminal 93 to the user terminal 93 (S135).

Then, the processing of the flowchart illustrated in the drawing ends.

When the TCP option area monitoring unit 14 of the relay server 91 does not detect MP_CAPABLE included in a synchronization packet (SYS) of the MPTCP received from the user terminal 93 (No in S125), a session reconfiguration scheme starts (S141). In this case, the transfer unit 15 cancels the session between the relay server 91 and the service server 92 (S142). Then, the transfer unit 15 establishes a session between the service server 92 and the user terminal 93 (S143).

### Destination IP Rewriting Operation of Relay Server 91

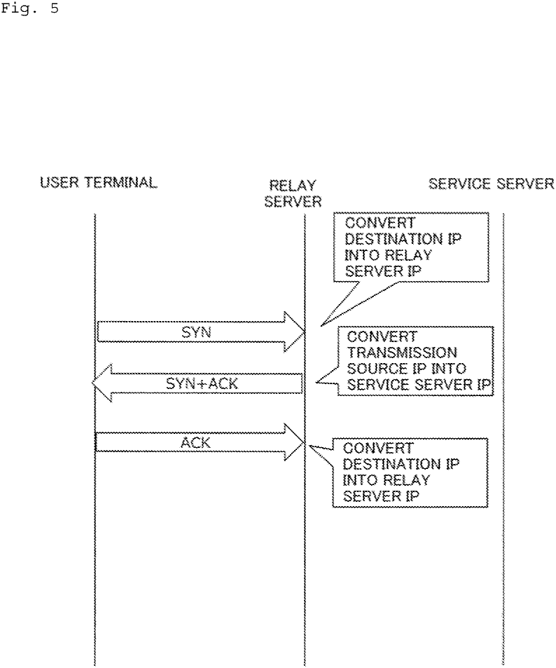

A destination IP rewriting operation will be described with reference to FIG. 5. The relay server 91 changes the destination IP address from the service server 92 to the IP address of the relay server 91. At this time, the IP address of the service server 92 is retained in a conversion table. After the session between the service server 92 and the user terminal 93 is established, the relay server 91 transfers a packet using the conversion table.

Specifically, the MPTCP functional unit 12 of the relay server 91 returns ACK in response to the received synchronization packet. At this time, with reference to the conversion table, the MPTCP functional unit 12 rewrites a transmission source address from the IP address of the relay server 91 to the IP address of the service server 92 to pretend that the user terminal 93 performs an operation of establishing the session with the service server 92.

Thus, in the present disclosure, the relay server 91 gives an illusion to the user terminal 93 as if the user terminal 93 had directly established the session with the service server 92. Also, the relay server 91 gives an illusion to the service server 92 as if the service server 92 had directly established the session with the user terminal 93.

### Session Establishment Process by TCP Port Number Unification

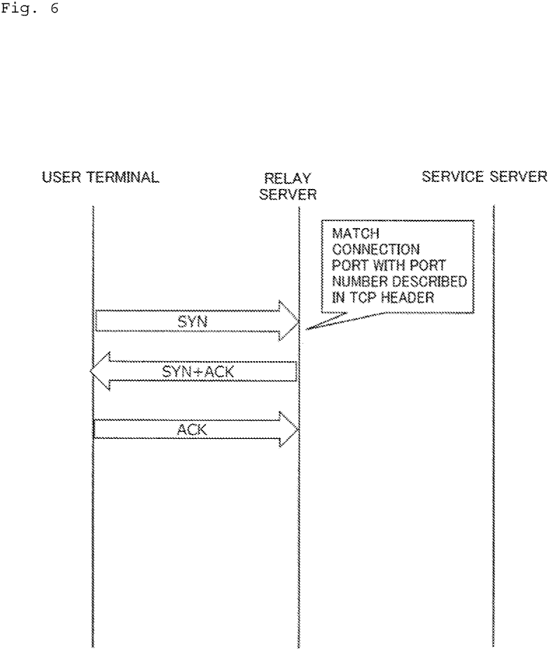

An operation of unifying TCP port numbers will be described with reference to FIG. 6. In the TCP, a session is established using a combination of IPs and port numbers. Accordingly, the present disclosure has a mechanism in which not only IPs but also port numbers are transferred by the relay server 91. Specifically, the IP rewriting unit 13 of the relay server 91 reads transmission/reception port numbers described in a TCP header and stores the transmission/reception port numbers in the conversion table. The IP rewriting unit 13 of the relay server 91 matches a connection port based on the conversion table and makes a connection with the user terminal 93. When a SYN + ACK packet is transmitted from the relay server 91 to the user terminal 93, the connection port is matched with a port number read from the conversion table.

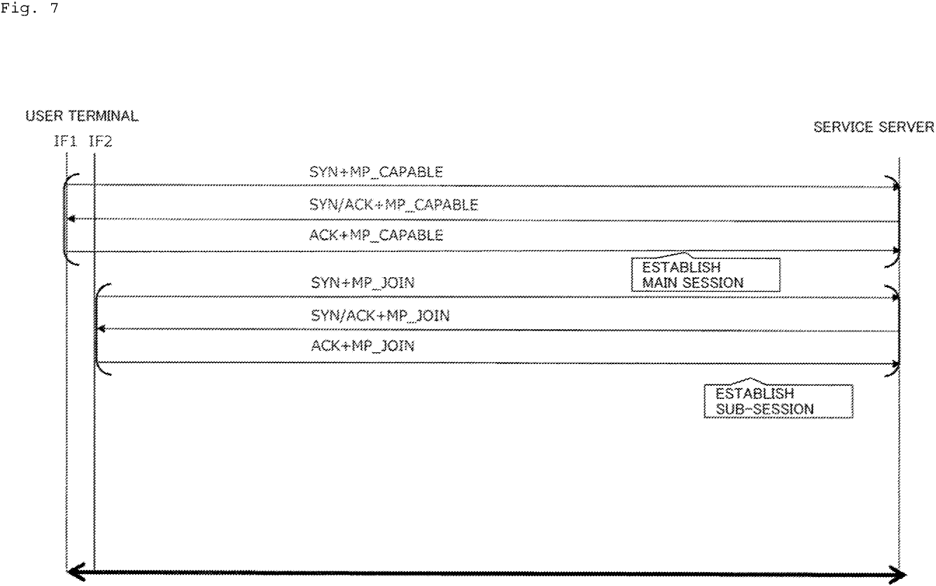

FIG. 7 is a diagram illustrating an example of a sequence at the time of connection of a user terminal in the related art. The MPTCP-compatible checking is performed in parallel with a TCP session operation by using the TCP option area. When the MPTCP is compatible between the user terminal and the service server 92, an MPTCP session is established.

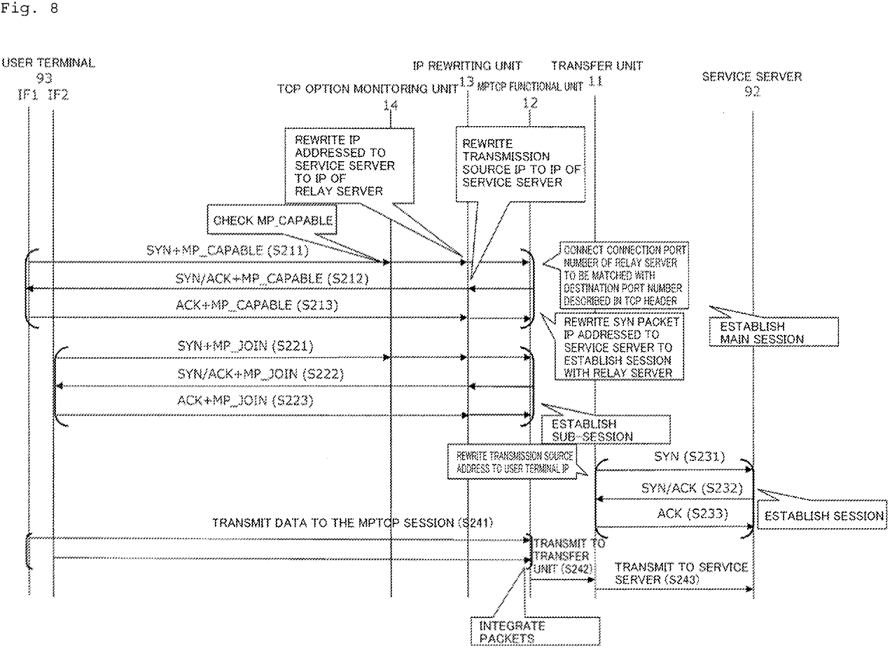

FIG. 8 is a diagram illustrating an example of a sequence at the time of connection of the user terminal in an uplink direction according to the present disclosure. The relay server 91 disguises the IP address as if the service server 92 and the user terminal 93 were directly communicating with each other from the viewpoint of the user terminal 93 and the service server 92. Thus, a MPTCP connection can be performed between the user terminal 93 and the relay server 91, so that a TCP connection can be performed between the relay server 91 and the service server 92.

For example, the relay server 91 establishes a session with the user terminal 93 by using the IP address of the service server 92 (S212, S213, S221, S222, and S223). The relay server 91 establishes a session with the service server 92 by using the IP address of the user terminal 93 (S231, S232, and S233). Thereafter, the relay server 91 transmits data along the MPTCP session (S241).

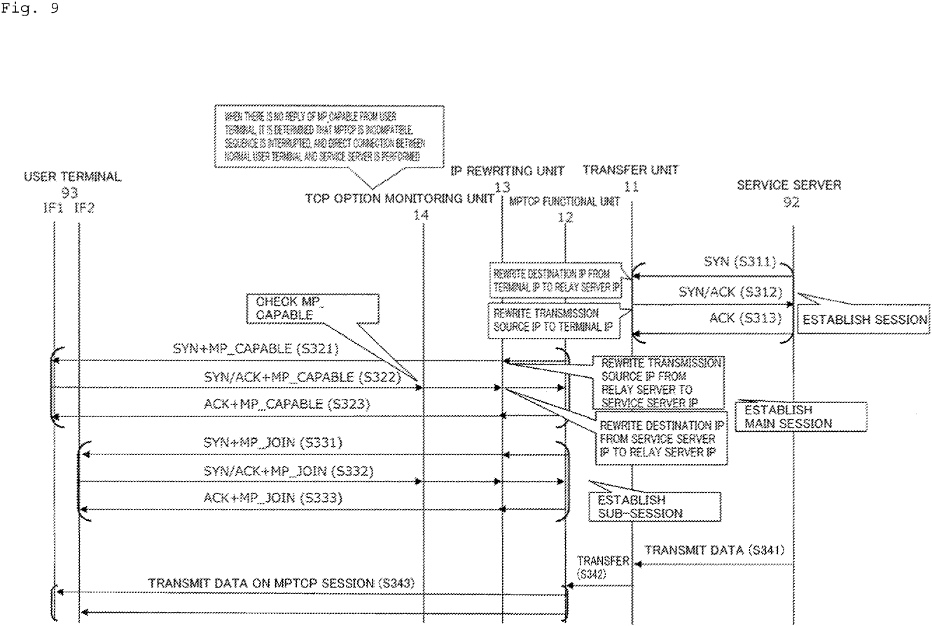

FIG. 9 is a diagram illustrating an example of a sequence at the time of connection of the user terminal in a downlink direction according to the present disclosure. The relay server 91 disguises the IP address as if the service server 92 and the user terminal 93 were directly communicating with each other from the viewpoint of the user terminal 93 and the service server 92. Thus, a MPTCP connection can be performed between the user terminal 93 and the relay server 91, so that a TCP connection can be performed between the relay server 91 and the service server 92.

For example, the relay server 91 establishes a session with the service server 92 by using the IP address of the user terminal 93 (S312 and S313). The relay server 91 establishes a session with the user terminal 93 by using the IP address of the service server 92 (S321, S322, S323, S331, S332, and S333). Thereafter, the relay server 91 transmits the data transmitted from the service server 92 (S341) on the MPTCP session with the user terminal 93 (S343).

In the above-described embodiment, the example in which the rewriting of the destination IP and the rewriting of the port number are performed with reference to the conversion table has been described. However, the rewriting of the destination IP and the rewriting of the port number can be realized by performing mapping of an IP address and a port number using an IP address of a network address and port translation (NAPT) and a TCP port conversion function. Specifically, the following functions provided in the NAPT are used:
conversion of an IP address in an IP header;
exchange of a port number of a TCP header; and
NAT traversal.

The relay server 91 reads IP header and TCP header information from a SYN packet transmitted by the user terminal 93 and rewrites the IP header and TCP header information.

For the IP header, the IP header of which a destination IP address is a service server IP is rewritten to the IP of the relay server 91.

For a port, a port of the relay server 91 is designated and connected to be matched with a port number of the read TCP header.

### Operation of TCP Option Area Monitoring Unit 14

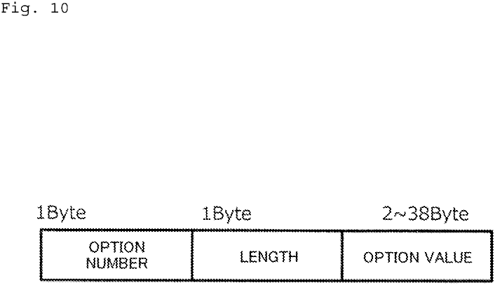

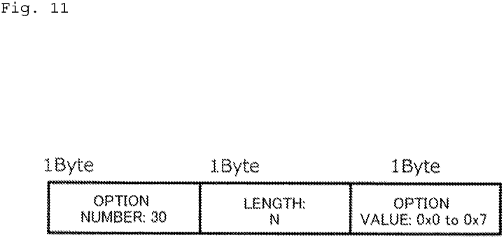

FIGS. 10 and 11 illustrate examples of a TCP option format and an MPTCP format.

As illustrated in FIG. 10, the TCP option format is defined by an option number, a length, and an option value. The option number and length are both 1 byte. As the option value, any value of 2 to 38 bytes can be adopted.

When MPTCP is used, option values defined in FIG. 11 are defined in RFC 8684. The MPTCP format is defined by the option number, the length, and the option value with 1 byte, as illustrated in FIG. 11. Accordingly, the TCP option area monitoring unit 14 monitors a TCP option number and determines whether the TCP option number is 30 or not.

### Sequence Number Storing and Proposing Technology

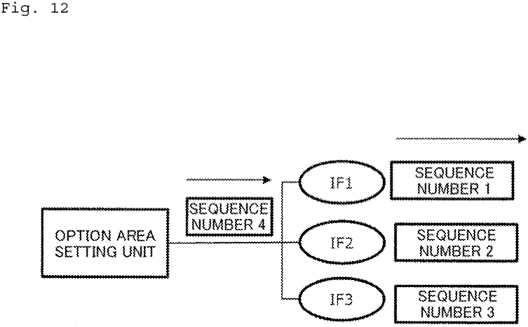

FIG. 12 is a diagram illustrating an example of sequence management and an option storage area. An MPTCP kernel of the user terminal 93 and the relay server 91 stores a sequence number in a TCP option area before data is transmitted. This is a sequence number unified between the multipaths, and the reception side can integrate packets between the multipaths by checking the sequence number.

### INDUSTRIAL APPLICABILITY

The present disclosure is applicable to information and communication industries.

### REFERENCE SIGNS LIST

| | |
|---|---|
| 11, 15 | Transfer unit |
| 12 | MPTCP functional unit |
| 13 | IP rewriting unit |
| 14 | TCP option area monitoring unit |
| 81, 82, 83 | Carrier network |
| 91 | Relay server |
| 92 | Service server |
| 93 | User terminal |

1. A communication system in which a terminal device and a service server incompatible with a multipath transmission control protocol (MPTCP) transmit and receive a packet, the communication system comprising:
a relay server connected between the service server and the terminal device,
wherein the relay server determines whether the terminal device is compatible with the MPTCP,
and when the terminal device is compatible with the MPTCP,
the relay server establishes an MPTCP main session and sub-session,
establishes a transmission control protocol (TCP) session with the service server, transmits and receives a packet to and from the service server using the TCP session, and
transmits and receives a packet to and from the terminal device using the MPTCP main session and sub-session.

2. A relay server connected between a terminal device and a service server incompatible with a multipath transmission control protocol (MPTCP), wherein the relay server determines whether the terminal device is compatible with the MPTCP,
and when the terminal device is compatible with the MPTCP,
the relay server establishes an MPTCP main session and sub-session,
establishes a transmission control protocol (TCP) session with the service server, transmits and receives a packet to and from the service server using the TCP session, and
transmits and receives a packet to and from the terminal device using the MPTCP main session and sub-session.

3. A communication method executed by a relay server connected between a terminal device and a service server incompatible with a multipath transmission control protocol (MPTCP),
wherein it is determined whether the terminal device is compatible with the MPTCP, And when the terminal device is compatible with the MPTCP,
an MPTCP main session and sub-session are established with the terminal device,
a transmission control protocol (TCP) session is established with the service server,
a packet is transmitted to and received from the service server using the TCP session, and
a packet is transmitted to and received from the terminal device using the MPTCP main session and sub-session.

4. A non-transitory computer-readable medium having computer-executable instructions that, upon execution of the instructions by a processor of a computer, cause the computer to function as the relay server according to claim 2.
